(19) United States
(12) Patent Application Publication
(10) Pub. No.: US 2008/0275918 A1
(43) Pub. Date: Nov. 6, 2008

(54) DOCUMENT MANAGEMENT APPARATUS AND COMPUTER READABLE MEDIUM

(75) Inventor: Toru Miura, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/018,234

(22) Filed: Jan. 23, 2008

(30) Foreign Application Priority Data
May 2, 2007 (JP) 2007-121899

(51) Int. Cl. G06F 17/00

(52) U.S. Cl. 707/200; 707/E17.005

(57) ABSTRACT

A document management apparatus includes a document storage section, a document transmission section, a determination section and a document update section. The document transmission section, when the document transmission section accepts a transmission request to transmit an electronic document, transmits the electronic document. The document transmission section stores history information including identification information of the user, the electronic document, and transmission timing. The determination section, when the determination section accepts a update request, from a first client, to update the certain electronic document, determines, based on the history information, as to whether or not the certain electronic document has already been updated after a transmission timing at which the first client made the transmission request.

### CROSS-REFERENCE TO RELATED APPLICATIONS

This application is based on and claims priority under 35 USC 119 from Japanese Patent Application No. 2007-121899 filed May 2, 2007

### BACKGROUND

1. Technical Field

This invention relates to a document management apparatus and a computer readable medium.

2. Related Arts

A document management apparatus that stores and manages an electronic document is known. Such a document management apparatus transmits the stored electronic document to a user apparatus such as a personal computer in response to a transmission request, from the user, to transmit the stored electronic document. The user edits the electronic document transmitted from the document management apparatus as required and makes a update request to update the electronic document stored in the document management apparatus with the electronic document edited by the user. The document management apparatus updates the stored electronic document, to the electronic document edited by the user, in response to the document update request made by the user.

In such a document management apparatus, if two or more users edit the same electronic document and update the electronic document, update contention may be occurred that the edit made by the previous user is lost as the later user conducts update.

### SUMMARY

According to an aspect of the invention, a document management apparatus includes a document storage section, a document transmission section, a determination section and a document update section. The document storage stores an electronic document. When the document transmission section accepts a transmission request to transmit a certain electronic document stored in the document storage section, the document transmission section transmits the certain electronic document. The document transmission section stores history information regarding to transmission. When the determination section accepts a update request, from a first client, to update the certain electronic document the determination section determines, based on the history information, as to whether or not the certain electronic document has already been updated after a transmission timing at which the first client made the transmission request. And the document update section executes the update request by the first client in accordance with a determination result.

### BRIEF DESCRIPTION OF THE DRAWINGS

An exemplary embodiment of the present invention will be described in detail based on the following figures, wherein:

FIG. 1 is a block diagram to represent a configuration example of a document management apparatus according to an exemplary embodiment of the invention;

FIG. 2 is a functional block diagram to represent a function example of the document management apparatus according to the exemplary embodiment of the invention;

FIG. 3 is a schematic representation to show one example of history information recorded by the document management apparatus according to the exemplary embodiment of the invention; and

FIG. 4 is a flowchart to show one example of processing executed by the document management apparatus according to the exemplary embodiment of the invention.

### DETAILED DESCRIPTION

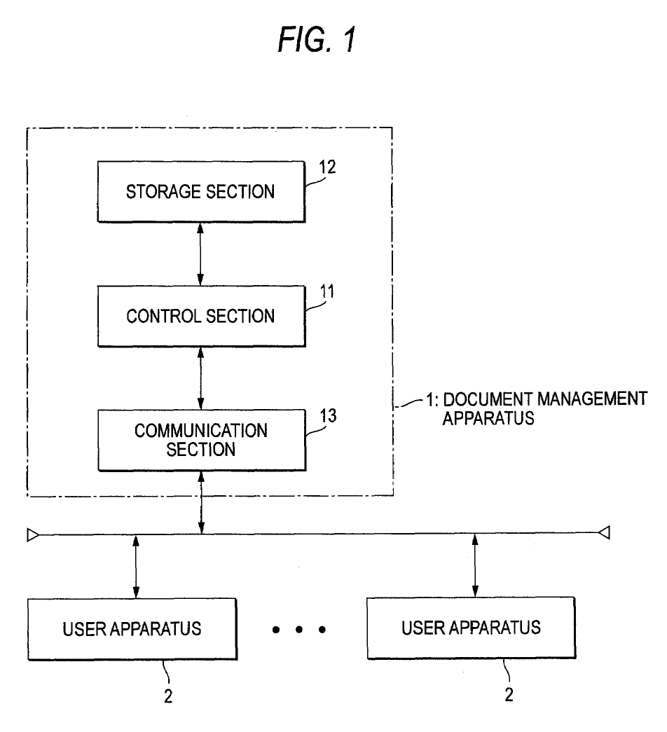

Referring now to the accompanying drawings, an exemplary embodiment of the invention is shown. A document management apparatus 1 according to the exemplary embodiment of the invention includes a control section 11, a storage section 12, and a communication section 13 as shown in FIG. 1. It is also connected to plural user apparatus 2 through communication line of a local area network, etc.

The control section 11 is, for example, a CPU, etc., and operates in accordance with a program stored in the storage section 12. In the exemplary embodiment, the control section 11 stores an electronic document in the storage section 12 and transmits an electronic document read from the storage section 12 in response to a request received from the user apparatus 2. An example of the processing executed by the control section 11 in the exemplary embodiment is described later.

The storage section 12 includes memory devices such as RAM and ROM and a computer-readable information storage medium such as a disk device of a hard disk, etc. A program executed by the control section 11 is stored in the storage section 12. The program may be provided through a communication line of the Internet, for example, or may be provided as it is stored on any of various computer-readable information storage media of a CD-ROM, a DVD-ROM, etc., for example. The storage section 12 also operates as working memory of the control section 11.

Further, in the exemplary embodiment, the storage section 12 stores one or more electronic documents to be managed by the document management apparatus 1. The electronic document is various pieces of computer-readable electronic information to be managed by the document management apparatus 1. The electronic document may be not only text data, but also drawing data, image data, audio data, etc., for example. Hereinafter, each electronic document stored in the storage section 12 of the document management apparatus 1 will be referred to as storage document.

The communication section 13 is a communication interface of a modem, a LAN card, etc., for example. It transmits information to the user apparatus 2 through the communication line in accordance with a command from the control section 11. The communication section 13 accepts information from the user apparatus 2 through the communication line and outputs the information to the control section 11.

The user apparatus 2 is, for example, a personal computer, etc., and is an information processing apparatus used by the user which accesses the document management apparatus 1. The user apparatus 2 transmits various processing requests to the document management apparatus 1 in accordance with command operation of the user. The user apparatus 2 also receives, from the document management apparatus 1, a response to the processing request. In the exemplary embodiment, two or more users use the document management apparatus 1 through any of plural user apparatus 2.

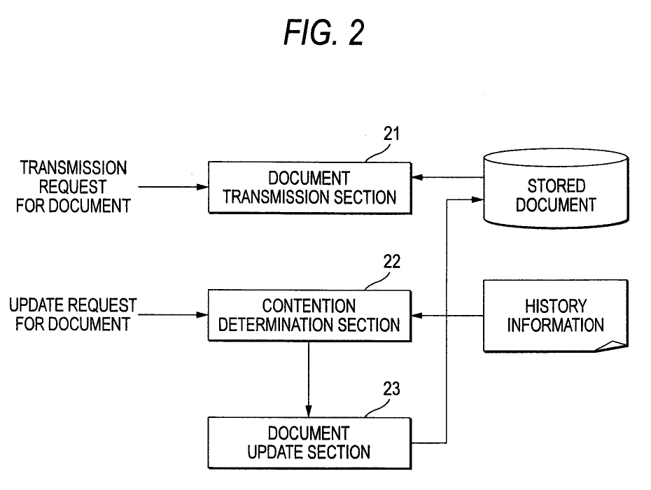

Next, the functions implemented by the document management apparatus 1 will be discussed based on an example of a functional block diagram of FIG. 2. As shown in FIG. 2, the document management apparatus 1 includes a document transmission section 21, a contention determination section 22, and a document update section 23. The functions can be implemented as the control section 11 which executes a program stored in the storage section 12.

The document transmission section 21 accepts a document transmission request from the user apparatus 2. It transmits the requested storage document to the user apparatus 2 in response to the accepted transmission request. Hereinafter, the storage document involved in the user's document transmission request to transmit will be referred to as target document (target electronic document).

As a specific example, first the user apparatus 2 transmits user identification information to the document management apparatus 1 in accordance with a user command, thereby logging on to the document management apparatus 1 and starting the use thereof. Further, the user apparatus 2 transmits a document transmission request containing information specifying the target document to the document management apparatus 1 in response to the user command. When the document transmission section 21 accepts the document transmission request, the document transmission section 21 references access right information set about the requested target document and determines whether or not the user logging on to the document management apparatus 1 has the authority to download the target document. When the document transmission section 21 determines that the user has the authority to download the target document, the document transmission section 21 performs transmission processing of transmitting data of the target document to the user apparatus 2. Accordingly, the user apparatus 2 downloads the target document and stores the downloaded target document data.

The document transmission section 21 stores history information. The history information includes (i) the user identification information which indicates the user makes the target document transmission request, (ii) the target document, and (iii) the transmission timing at which the user makes the transmission request.

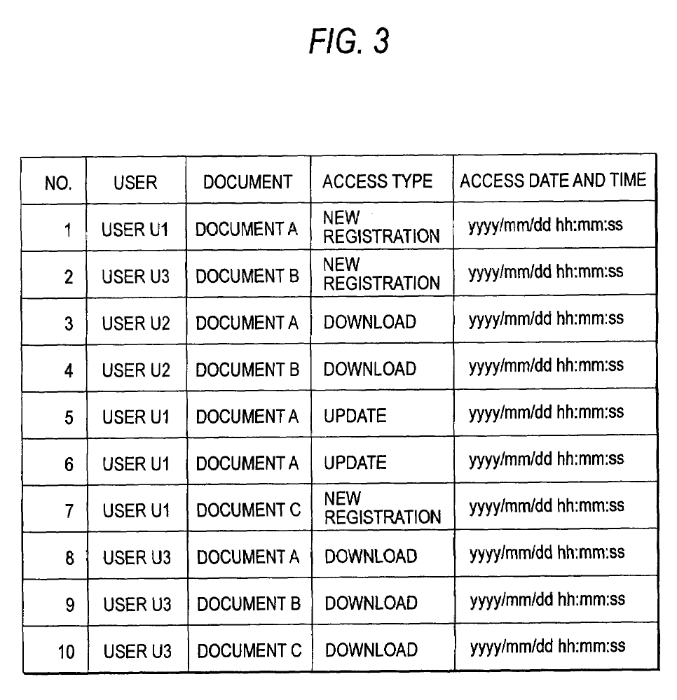

Such storing processing which stores history information is performed, whereby history information L concerning a history of users' access to each target document is stored in the storage section 12 of the document management apparatus 1. FIG. 3 is a schematic representation to show one example of the descriptions of the history information L recorded by the document management apparatus 1. In the example in FIG. 3, for each access, user identification information for identifying the user accessing an electronic document, document specification information for specifying the accessed electronic document, information indicating the access type (download, new registration, update, etc.,), and access date and time information are stored in association with each other. In the example in FIG. 3, each record with the access type “download” is history information of transmission processing performed by the document transmission section 21. In FIG. 3, the larger the number, the more recent is the access history information; the smaller the number, the older is the access history information. In the exemplary embodiment, the access date and time information is adopted, but may be any access timing information such as access date information.

In the example in FIG. 3, access from two or more users and various types of access are managed under one history information L, but the history information L may be generated for each user or only the history information L concerning transmission processing may be recorded.

The user downloading a target document from the document management apparatus 1 by performing the above-described processing may simply reference the downloaded target document on the user apparatus 2 or may edit the target document on the user apparatus 2 to update the contents of the target document. The user apparatus 2 creates an electronic document with the contents changed from the former target document according to the edit. The electronic document thus edited by the user based on the target document transmitted from the document management apparatus 1 will be hereinafter referred to as already edited document.

The contention determination section 22 accepts a document update request to update one electronic document of the storage documents to an already edited document from the user apparatus 2. The document update request contains information for specifying the user making the document update request (who will be hereinafter referred to as update requesting user), information for specifying the electronic document to be updated, and the data of the already edited document.

Updating of electronic document may be processing of deleting the electronic document to be updated, stored in the storage section 12 and replacing the electronic document with the already edited document transmitted from the user apparatus 2 or may be processing of additionally registering the already edited document as a new version of the electronic document to be updated. In either case, if update contention occurs between or among the users, it is feared that the most recent version of the updated electronic document will not reflected the edits made by the users.

The contention determination section 22 accepting the document update request performs contention determination processing of determining whether or not two or more users update request race about updating electronic document based on the history information L. Specifically, the contention determination section 22 determines based on the history information L whether or not the document update section 23 updated the target document after the document transmission section 21 transmitted the electronic document to be updated (namely, the electronic document on which the already edited document was based) to the update requesting user in the past as the target document. Further, the contention determination section 22 determines whether or not the electronic document to be updated is to be updated in response to the determination result. The details of the processing executed by the contention determination section 22 are described later.

If the contention determination section 22 determines that the electronic document is to be updated, the document update section 23 updates the electronic document involved in the document update request with the already edited document transmitted together with the document update request. Accordingly, the most recent version of the updated electronic document becomes the already edited document on which the result of the edit made by the update requesting user is reflected.

When the document update section 23 updates an electronic document, the document update section 23 may add information associating the identification information indicating the update requesting user, the updated electronic document, and the update timing with each other to the history information L. In the example in FIG. 3, each record with the access type “update” is history information of the update processing performed by the document update section 23.

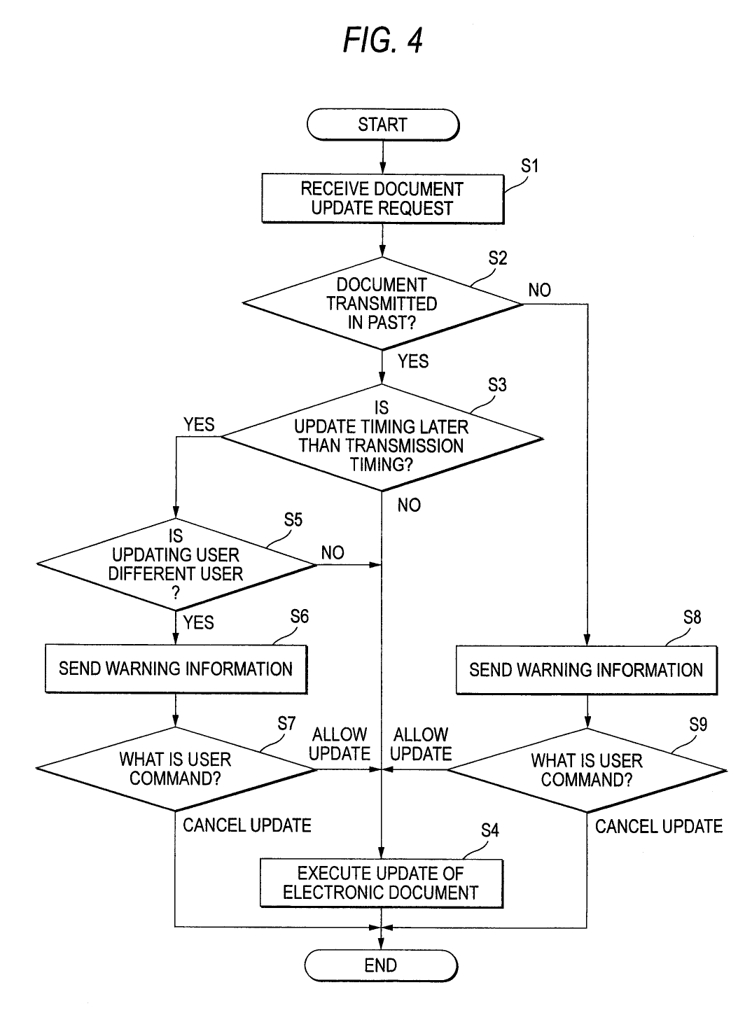

A specific example of processing executed by the contention determination section 22 and the document update section 23 will be discussed with a flowchart of FIG. 4.

First, the contention determination section 22 receives a document update request from the user apparatus 2 (S1). It determines whether or not the electronic document to be updated and specified by the document update request is a target document transmitted in the past to the update requesting user (S2). Specifically, the contention determination section 22 searches the history information L to determine whether or not a history of downloading the electronic document to be updated by the update requesting user in the past is contained in the history information L. For example, assuming that the history information L illustrated in FIG. 3 is stored in the storage section 12 and that the electronic document to be updated is document A and the update requesting user is user U2, it can be determined that the electronic document to be updated was transmitted in the past to the user U2 according to the record indicted by number 3.

If the contention determination section 22 determines at S2 that the electronic document to be updated was transmitted to the update requesting user in the past included in the history information, further the contention determination section 22 makes a comparison between the transmission timing indicated by the history information and the past update timing of the electronic document to be updated, and determines whether or not the update timing is later than the transmission timing (S3). Here, the past update timing of the electronic document to be updated may be determined by referencing the update timing information stored in association with each electronic document or may be determined by the timing information indicated by the history of updating the electronic document contained in the history information L. For example, in the example in FIG. 3 described above, the document A is updated last by the user U1 and the access date and time indicated by the record with number 6 becomes the update timing of the document A. This timing is later than the transmission timing of transmitting the document A to user A2.

If it is determined at S3 that the update timing is earlier than the transmission timing, nobody updates the electronic document after the timing at which the update requesting user downloaded the electronic document to be updated, and it is considered that there is no fear of update contention. Then, the contention determination section 22 determines that the electronic document is to be updated. In response to the determination, the document update section 23 updates the electronic document to be updated with the already edited document (S4).

If it is determined at S3 that the update timing is later than the transmission timing, further whether or not the user updating the electronic document is a different user from the update requesting user (S5). In the example described above, the update requesting user is the user U2; whereas, the user last updating the document A is the user U1. Therefore, it is determined that a different user updates the document A after the user U2 downloaded the document A.

If it is determined at S5 that the user executing the last update is a different user other than the update requesting user, it is feared that update contention may occur between the user and the different user. Then, the contention determination section 22 transmits warning information of a predetermined message to the user apparatus 2, thereby notifying the update requesting user of the warning information (S6). The warning information may include not only message information to the effect that the electronic document to be updated is updated after it was downloaded by the update requesting user, but also information concerning the update timing and the user updating the electronic document.

If the update requesting user receives such warning information, he or she specifies whether or not the electronic document is to be updated by operating the user apparatus 2. The contention determination section 22 accepts the command (specification) of the update requesting user transmitted from the user apparatus 2 and determines whether or not the electronic document is to be updated in response to the accepted command (specification) (S7). That is, if the command of the update requesting user is to allow the electronic document to be updated, update processing is executed (S4). On the other hand, if the command is to skip updating the electronic document, the updating is canceled and the processing is terminated.

If it is determined at S5 that the user executing the last update is the update requesting user, it is considered that update contention will not occur between the user and a different user. Then, the contention determination section 22 determines that the electronic document to be updated is to be updated. In response to the determination, the document update section 23 performs update processing of the electronic document to be updated (S4). Here, if the past update is executed by the same user, the update is permitted; however, the user can forget editing the document in the past by him or her and can attempt to again edit and update the target document. Then, if the electronic document to be updated is updated by the update requesting user after the electronic document to be updated is transmitted to the update requesting user, the contention determination section 22 may also send warning information to the update requesting user as at S6. In this case, the determination processing at S5 becomes unnecessary.

On the other hand, if it is determined at S2 that there is not a history of transmitting the electronic document to be updated to the update requesting user in the past, the user may make erroneous specification of the electronic document to be updated. Then, the contention determination section 22 sends warning information making reference to absence of download history, different from that at S6 to the update requesting user (S8). If the update requesting user receives the warning information at S8, still he or she specifies whether or not the electronic document is to be updated. The contention determination section 22 determines whether or not the electronic document is to be updated in response to the command (specification) (S9). According to this determination, the document update section 23 performs update processing (S4) or update processing is canceled.

The exemplary embodiment of the invention is not limited to the example described above. In the above-described example, if the target document is updated after the update requesting user downloads the target document, warning information is sent to the update requesting user, but the exemplary embodiment of the invention is not limited to the mode; for example, update processing may always be canceled or the already edited document may be newly registered as a new storage document.

In the description given above, the download histories in all time periods contained in the history information L are searched and the transmission timing of transmitting the target document to the update requesting user in the past is determined. However, if the downloading timing of the target document is a very old timing, generally it is hard to consider that the user may edit and update a document based on such a target document. Then, the contention determination section 22 may perform contention determination processing based on the history information L over a predetermined past time period (for example, one year). As a specific example, at S2, the contention determination section 22 searches the history information L within the past year, thereby determining whether or not the electronic document to be updated is a target document transmitted to the update requesting user within the past year. If the update requesting user attempts to update according to the electronic document edited based on the target document downloaded one year or more before, the contention determination section 22 may send warning information for alerting the user to the fact.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a document storage section that stores an electronic document;
a document transmission section that, when the document transmission section accepts a transmission request to transmit a certain electronic document stored in the document storage section, transmits the certain electronic document the document transmission section that stores history information regarding to transmission;
a determination section that, when the determination section accepts a update request, from a first client, to update the certain electronic document, determines, based on the history information, as to whether or not the certain electronic document has already been updated after a transmission timing at which the first client made the transmission request; and
a document update section that executes the update request by the first client in accordance with a determination result.

2. The document management apparatus according to claim 1,
wherein the determination section that further determines as to whether or not the certain electronic document has been updated in accordance with the update request made by a second client different from the first client.

3. The document management apparatus according to claim 1,
wherein the determination section further determines based on the history information over a predetermined past time period.

4. The document management apparatus according to claim 2,
wherein the determination section further determines based on the history information over a predetermined past time period.

5. The document management apparatus according to claim 2,
wherein the determination section notifies a warning information to the first client when the certain electronic document has been updated based on the update request made by the another client different from the first client.

6. The document management apparatus according to claim 5,
wherein the determination section prompts the first client to specify as to whether or not to execute the update request when the warning information is notified to the first client.

7. The document management apparatus according to claim 6,
wherein the document update section executes the update request made by the first user, when the determination section receives a instruction that the first user instructs to execute the update request.

8. The document management apparatus according to claim 1,
wherein the history information includes (i) identification information of the first client which makes the transmission request, (ii) the certain electronic document and (iii) a transmission timing at which the first user makes the transmission request in association with each other.

9. The document management apparatus according to claim 1,
wherein the update request is a request to update the certain document to an electronic document created by editing based on the certain electronic document.

10. A computer readable medium storing a program causing a computer to execute a process for managing documents, the process comprising:
transmitting the certain electronic document when accepting a transmission request to transmit a certain electronic document stored in the document storage section;
storing history information regarding to transmission;
determining, based on the history information, when accepting a update request, from a first client, to update the certain electronic document, as to whether or not the certain electronic document has already been updated after a transmission timing at which the first client made the transmission request; and
executing the update request made by the first client in accordance with a determination result.

11. The computer readable medium as claimed in claim 10,
wherein in the determining process, further determines as to whether or not the certain electronic document has been updated in accordance with the update request made by a second client different from the first client.

12. The computer readable medium as claimed in claim 10,
wherein in the determining process, further determines based on the history information over a predetermined past time period.

13. The computer readable medium as claimed in claim 11,
wherein in the determining process, further determines based on the history information over a predetermined past time period.

14. The computer readable medium as claimed in claim 12, the process further comprising:
notifying warning information to the first client when the certain electronic document has been updated based on the update request made by the another client different from the first client.

15. The computer readable medium as claimed in claim 14, the process further comprising:
prompting the first client to specify as to whether or not to execute the update request when the warning information is notified to the first client.

16. The computer readable medium as claimed in claim 15, the process further comprising:
executing the update request made by the first client, when receiving a instruction that the first user instructs to execute the update request.

17. The computer readable medium as claimed in claim 10, the process further comprising:
the history information includes (i) identification information of the first client which makes the transmission request, (ii) the certain electronic document and (iii) a transmission timing at which the first user makes the transmission request in association with each other.

18. The computer readable medium as claimed in claim 10, the process further comprising:
the update request is a request to update the certain document to an electronic document created by editing based on the certain electronic document.
